(19) United States
(12) Patent Application Publication
(10) Pub. No.: US 2005/0201708 A1
(43) Pub. Date: Sep. 15, 2005

(54) Method and device for manufacturing bare optical fiber

(76) Inventors: Koichi Arishima, Tokyo (JP); Yoshi Kurosawa, Tokyo (JP); Masaru Kobayashi, Tokyo (JP); Mamoru Hirayama, Tokyo (JP); Ryo Nagase, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 10/507,265

(22) PCT Filed: Mar. 14, 2003
(86) PCT No.: PCT/JP03/03100

§ 371 Date: Sep. 10, 2004

(30) Foreign Application Priority Data
Mar. 18, 2002 (JP) 2002-073568

(51) Int. Cl. G02B 6/00

(52) U.S. Cl. 385/134

(57) ABSTRACT

An object of the present invention is to provide a method for manufacturing a bared optical fiber having a good end surface of a coating when the coating of the coated optical fiber is removed, and a device for manufacturing the same. To achieve the above object, according to the invention, a laser beam is applied to an coated optical to fuse the coating or work the coating in other manners, if a coating material has a lower melting point as compared with the material of the bared optical fiber to remove the coating, whereby a bared optical fiber is manufactured. In addition, a cyanogen gas generated when the coating of the coated optical fiber is fused or worked in other manners is decomposed by ozone, thereby being made harmless.

### TECHNICAL FIELD

The present invention relates to a method for manufacturing a bared optical fiber by well removing the coating from a coated optical fiber, and a device for manufacturing the same.

### BACKGROUND ART

With the increasing introduction of an optical communication system, a coating for protecting an bared optical fiber needs to be removed with high precision when bared optical fibers are fused and spliced to each other and when an bared optical fiber is worked into an optical connector. Further, the technological development of wavelength division multiplexing transmission has advanced to cope with a request for increasing communication capacity and the coating of a coated optical multi fiber has been required to be efficiently removed when the coated optical multi fiber is connected to an arrayed waveguide type wavelength division multiplexer/demultiplexer which applies to wavelength division multiplexing transmission. Still further, in order to reduce the size of an optical fiber coupler, the selective removal of only a portion to be fused of the coating from the coated optical fiber has become an critical problem.

For example, in a glass optical fiber for communications, a bared optical fiber made of glass is primarily coated with a resin or the like and is secondarily coated with a resin or the like to protect the bared optical fiber. To make the coated optical fiber be a bared optical fiber, both of the primary coating and the secondary coating need to be removed.

Moreover, in the manufacturing of a coated optical glass multi fiber, a bared optical fiber made of glass is primarily coated with a resin or the like and plurality of these primary coated optical fibers are arranged and integrally formed by means of a secondary coating material. Hence, to make the coated optical multi fiber be bared optical fibers, both of the primary coating and the secondary coating need to be removed.

As for a conventional tool for removing the coating of the coated optical fiber, a wire stripper has been widely used for removing the coating of a single coated optical fiber and a hot stripper has been widely used for removing the coating of a coated optical multi fiber. The wire stripper grips the coating by metallic blades, each of which has a diameter a little larger than the diameter of the bared optical fiber and is cut out in a circular shape, and cuts and removes only the coating. Further, the hot stripper heats the coating to be removed, and then cuts the softened coating by metallic blades put on the coating.

However, in either of these two cases, when the coating is completely cut, these tools might damage even a bared optical fiber. Hence, when the coating is cut up to a certain point, the coating is removed by a shearing stress and a pulling force. This makes the end surface of the remaining coating uneven. Further, since the metallic blades are put on the coated optical fiber, in a case where the metallic blades cause damage to the surface of the bared optical fiber, the damage becomes causes of the occurrence of cracks or a break in the bared optical fiber. Still further, it is impossible to remove the coating only at the midpoint position of the coated optical fiber.

In the case of removing the coating by use of the hot stripper, the coating is removed by a shearing stress and a pulling force. Hence, in the case of a coated optical multi fiber having about 8 fibers or more, it is difficult even to press the metallic blades onto the coated optical multi fiber at a uniform pressing force and the pulling force exceeds the limit of manual pulling force. Further, in the case of the coated optical multi fiber having about 8 fibers or more, it is difficult to heat the entire coating uniformly and hence the end surface of the remaining coating becomes uneven.

To solve the above problems, an object of the invention is to provide a method for manufacturing a bared optical fiber having a good end surface of a coating, and a device for manufacturing the bared optical fiber.

### DISCLOSURE OF THE INVENTION

To achieve the above-described object, according to a first aspect of the invention, there is provided a method for manufacturing a bared optical fiber in which a laser beam is applied to a coated optical fiber: to fuse a coating if a coating material has a lower melting point as compared with a material of the bared optical fiber; to fuse and volatilize the coating if the coating material has a lower volatilizing point as compared with the material of the bared optical fiber; to sublimate the coating if the coating material has a lower sublimating temperature as compared with the material of the bared optical fiber; to thermally oxidize and decompose the coating if the coating material has a lower thermally oxidizing temperature as compared with the material of the bared optical fiber; or to fuse, fuse and volatilize, sublimate, or thermally oxidize and decompose the coating if the coating material has a higher index of absorption of a laser beam as compared with the material of the bared optical fiber, thereby removing the coating.

In accordance with a second aspect of the invention, there is provided a method for manufacturing a bared optical fiber in which a laser beam is applied to a coated optical fiber to photolyze a coating if a coating material is easily photolyzed as compared with a material of the bared optical fiber, or to photolyze the coating if the coating material has a higher index of absorption of a laser beam as compared with the material of the bared optical fiber, thereby removing the coating.

In accordance with a third aspect of the invention, there is provided a device for manufacturing a bared optical fiber, comprising a laser applying part that applies a laser beam to an caoted optical fiber to remove a coating of the coated optical fiber.

The first aspect of the invention and the second aspect of the invention also include the features that the laser beam is collected in the shape of a belt or a line and is applied to the coated optical fiber in an axial direction of the coated optical fiber or in a direction crossing the axial direction, that plurality of laser beams are applied to the coated optical fiber from different directions, that the laser beam is applied to the coated optical fiber while the laser beam is being moved in an axial direction of the coated optical fiber or in a direction crossing the axial direction, and that plurality of laser beams are applied to the same portion of the coated optical fiber at the same time. The first aspect of the invention and the second aspect of the invention also include the feature that the coated optical fiber is a coated optical multi fiber or taped optical multi fiber having bared optical fibers integrally formed by means of the coating material.

The first aspect of the invention also includes the feature that the laser beam is generated by a carbon dioxide gas laser.

The first aspect of the invention also includes the feature that the laser beam is generated by a semiconductor laser.

The second aspect of the invention also includes the feature that the laser beam is generated by an excimer laser.

The first aspect of the invention and the second aspect of the invention also include a means that exhausts gas generated when the laser beam is applied to the coated optical fiber. Further, the first aspect of the invention and the second aspect of the invention also include a means that makes a cyanogen gas of exhausted gas react with an alkaline liquid to dissolve the cyanogen gas in the alkaline liquid, and still further include a means that further decomposes the dissolved cyanogen by ozone.

The first aspect of the invention and the second aspect of the invention also include the feature that inert gas is introduced to a portion of the coated optical to which the laser beam is applied.

The third aspect of the invention also includes the features that the laser applying part collects a laser beam on the coated optical fiber in the shape of a belt or a line and applies the laser beam to the coated optical fiber in an axial direction of the coated optical fiber or in a direction crossing the axial direction; that the laser applying part applies plurality of laser beams to the coated optical fiber from different directions; that the laser applying part applies the laser beam to the coated optical fiber while the laser beam is being moved in an axial direction of the coated optical fiber or in a direction crossing the axial direction; that the laser applying part applies plurality of laser beams to the same portion of the coated optical fiber at the same time; and that the laser applying part applies the laser beam to a coated optical multi fiber having bared optical fibers integrally formed by means of the coating material to remove the coating.

The third aspect of the invention also includes the feature that the laser applying part comprises a carbon dioxide gas laser, a semiconductor laser, or an excimer laser.

The third aspect of the invention also includes a means that exhausts gas generated when the laser beam is applied to the coated optical fiber. Further, the third aspect of the invention also includes a means that makes a cyanogen gas of the exhausted gas react with an alkaline liquid to dissolve the cyanogen gas in the alkaline liquid, and still further includes a means that further decomposes the dissolved cyanogen by ozone.

The third aspect of the invention also includes a means that introduces inert gas to a portion of the coated optical fiber to which the laser beam is applied.

In this regard, these constructions can be combined with each other where possible.

### BRIEF DESCRIPTION OF THE DRAWINGS

FIG. 1 is an illustration to show a process for removing the coating of a coated single optical fiber which is an embodiment of the present invention.

FIG. 2 is an illustration to show a process for removing the coating of a coated optical multi fiber which is an embodiment of the present invention.

FIG. 3 is an illustration to show a bared optical fiber whose coating is removed according to the present invention.

FIG. 4 is illustrations to show the boundary surfaces of coatings of the coated optical fibers wherein the coatings are removed according to a conventional technology and the present invention.

FIG. 5 is an illustration to show a process for removing the coating of a coated optical multi fiber which is an embodiment of the present invention.

FIG. 6 is an illustration to show a process for removing the coating to which an exhaust gas treating system and a waste liquid treating system in accordance with the present invention are connected.

The reference symbols in the drawings will be described as follows: 11—LASER, 12—laser beam, 13—mirror, 15—gas nozzle, 16—coated single optical fiber, 17—stage, 21—beam expander, 22—half mirror, 23—cylindrical lens, 24—optical multi fiber, 31—hollow fiber, 41—coated optical multi fiber having bared optical fibers integrally formed in the shape of a tape by means of a coating material, 42—bared optical fiber portion from which coating is removed, 51—chamber, 52—alkaline liquid, 53—aspirator, 54—mercury lamp, 55—carbon dioxide laser, 56—control system, 57—exhaust gas treating system, 58—waste liquid treating system, 59—waste liquid and 60—nitrogen gas.

### BEST MODE FOR CARRYING OUT THE INVENTION

Hereinafter, modes for carrying out the present invention will be described in detail, but it should be understood that the present invention is not limited to these modes.

### Embodiment 1

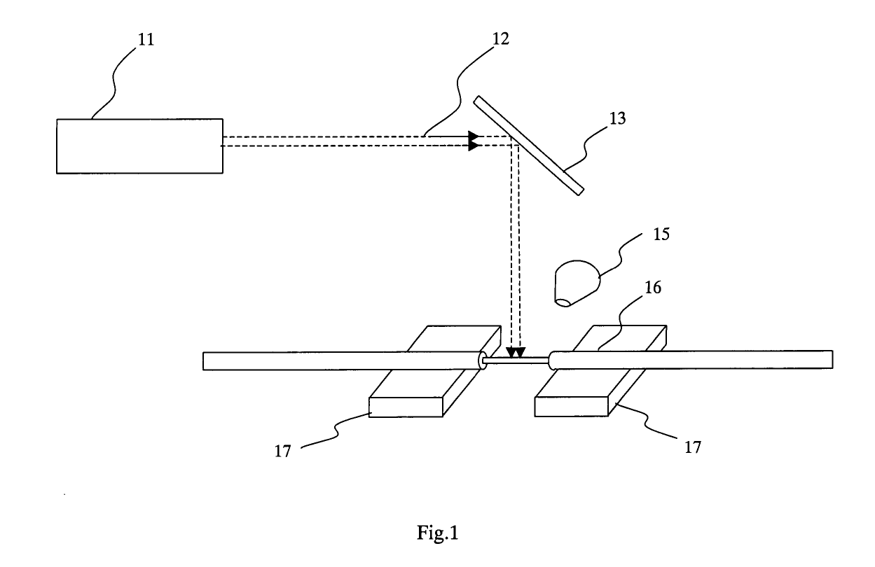

An embodiment of removing the coating of a coated single optical fiber is shown in FIG. 1. A reference numeral 11 denotes a LASER for emitting a laser beam 12, 13 denotes a mirror for reflecting the laser beam, 15 denotes a gas nozzle for blowing inert gas over a portion of the coated optical fiber to which the laser beam 12 is applied, 16 denotes a coated single optical fiber whose coating is to be removed, and 17 denotes a stage for moving the coated single optical fiber 16 in the axial direction of the coated optical fiber.

The stage 17, although not shown, is provided with a clamping part for griping the optical fiber. All that this clamping part needs to do is to fix the optical fiber to prevent the optical fiber from moving and the clamping part does not need to apply a heavy pressing force to the optical fiber, dislike a conventional wire stripper. Hence, the clamping part can have a simple structure and its portion that presses the optical fiber can be made short in length. Therefore, there is provided an advantage that the removal of the coating of a short coated optical fiber, which was difficult in the conventional technology, can be easily performed.

Next, the operation of the present embodiment will be described. The laser beam 12 from the LASER 11 is reflected by the mirror 13, thereby being applied to the coated single optical fiber 16. The laser beam can be efficiently applied from a direction at a right angle to the axis of the coated optical fiber. In this embodiment, a carbon dioxide gas laser is used as the LASER 11. If a coating material has a lower melting point as compared with the material of the bared optical fiber, the coating can be selectively fused by applying the laser beam of a carbon dioxide gas laser to the coated optical fiber. Further, if the coating material has a lower volatilizing temperature as compared with the material of the bared optical fiber, the coating can be selectively fused and volatilized. Still further, if the coating material has a lower sublimating temperature as compared with the material of the bared optical fiber, the coating can be selectively sublimated. Still further, if the coating material has a lower thermal oxidizing temperature as compared with the material of the bared optical fiber, the coating can be selectively thermally oxidized and decomposed.

An organic material constructing the coating of the optical fiber is substantially different in the index of absorption of laser light from quartz-based glass constructing the bared optical fiber. For example, in the case of the carbon dioxide gas laser having a wavelength of 10.6 μm, the index of absorption of the coating of the coated optical fiber is about 10%, whereas that of the bared optical fiber is about 0.000001%, which is greatly different therebetween. Hence, if the intensity of a laser applied to the coated optical fiber is appropriately set, only the coating of the coated optical fiber can be removed by fusion or the like.

A high-power semiconductor laser can be used as the LASER 11. If the intensity of the semiconductor laser is appropriately set, only the coating of the coated optical fiber can be selectively removed by fusion or the like. An exciting laser light source used for optical fiber amplification can be used as a high-power semiconductor laser. For example, an exciting laser light source having a wavelength of 0.98 μm or 1.48 μm and a power of about 0.3 W can be used. Since the high-power semiconductor laser is small in size and can be easily maintained and operated, it is more advantageous as compared with a gas laser or a solid state laser.

If an excimer laser is used as the LASER 11, a laser beam is applied to the coated optical fiber to decompose the coating optically. If the coating material is more easily photolyzed as compared with the material of the bared optical fiber, the coating can be selectively photolyzed. Or, if the coating material has a higher index of absorption as compared with the material of the bared optical fiber, the coating can be selectively photolyzed.

The coated single optical fiber 16 is gripped by the clamping part of the stage 17 and the stage 17 is moved in the axial direction of the coated optical fiber, so that the laser beam 12 removes the coating of the coated single optical fiber 16 by fusion or the like. In this manner, the coating can be removed along the axial direction of the coated optical fiber. The same effect can be obtained also by fixing the stage 17 and moving the mirror 13 in the axial direction of the coated optical fiber. If the laser beam is collected in the shape of a belt or a line and is applied to the coated optical fiber in its axial direction, the coating can be removed along the axial direction of the coated optical fiber without moving the stage 17 or the mirror 13.

A nitrogen gas as inert gas is blown from the gas nozzle 15 to discharge an oxygen atmosphere from the vicinity of a portion to which the laser beam is applied. The nitrogen gas is used to prevent the bared optical fiber from being deteriorated in strength. The tensile strength (Kgf, stress when one optical fiber is broken) of a coated single optical fiber with a diameter of 250 μm whose midpoint portion is irradiated with the carbon dioxide laser to have its coating removed is shown in Table 1. Table 1 shows tensile strength under a nitrogen atmosphere and tensile strength under an oxygen atmosphere in comparison. In this regard, to make a nitrogen atmosphere, a nitrogen gas was blown over a portion irradiated with the laser by the gas nozzle. As can be seen from Table 1, tensile strength under the nitrogen atmosphere is more excellent than tensile strength under the oxygen atmosphere in three test results.

TABLE 1

Under nitrogen atmosphere
Under oxygen atmosphere

If the coating of the coated single optical fiber is removed according to the present invention, the coating is not mechanically removed as in the case of the hot stripper, so that the end surface of coated the optical fiber from which the coating is removed becomes smooth.

### Embodiment 2

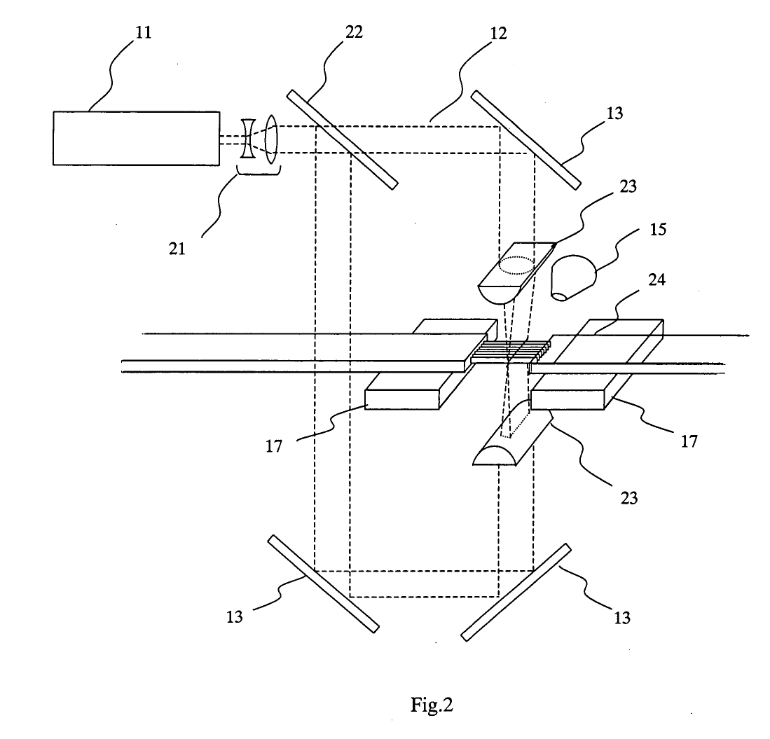

An embodiment of removing the coating of the coated optical multi fiber is shown in FIG. 2. A reference numeral 11 denotes a LASER for emitting a laser beam 12, 21 denotes a beam expander for expanding the laser beam, 22 denotes a half mirror, 13 denotes a mirror for reflecting the laser beam, 23 denotes a cylindrical lens for focusing a circular laser beam into the shape of a belt, 15 denotes a gas nozzle for blowing inert gas over a portion of the coated optical fiber to which the laser beam 12 is applied, 24 denotes a coated optical multi fiber having bared optical fibers integrally formed in the shape of a tape by means of a coating material, and 17 denotes a stage for moving the optical multi fiber 24 in an axial direction of the coated optical multi fiber.

The stage 17, although not shown, is provided with a clamping part for griping the coated optical fiber. All that this clamping part needs to do is to fix the coated optical fiber to prevent the coated optical fiber from moving and the clamping part is not required to apply a heavy pressing force to the coated optical fiber, dislike a conventional wire stripper. Hence, the clamping part can have a simple structure and a portion of the clamping part that presses the coated optical fiber can be made short in length. Therefore, there is also provided an advantage that the removal of the coating of a short coated optical fiber, which was difficult in the conventional technology, can be easily performed.

In this embodiment, a carbon dioxide gas laser having a power of 200 W was used as the LASER 11. The laser beam emitted from the carbon dioxide gas LASER 11 is expanded by the beam expander 21 and is then divided into two beams each having a light quantity of about 50%. Of the divided laser beams, an upper laser beam is once reflected by the mirror 13, and a lower laser beam is twice reflected by the mirror 13 and each of the upper and lower laser beams is focused into a belt-shaped laser beam or a line-shaped beam by the cylindrical lens 23. The laser beams are applied to almost the same position of the coated optical multi fiber 24 at a right angle to the coated optical fiber from the upper and lower directions at the same time. By applying the laser beams to the same position from the upper and lower directions at the same time, the coating can be efficiently removed and the work is completed in a short time. Further, since the laser beams are applied to the coated optical multi fiber 24 from both the directions, the quantity of heat applied to the coated optical multi fiber 24 from each direction can be reduced, which can prevent the bared optical fibers from being oxidized and deteriorated in characteristics. The effect of applying the laser beams to the coated optical fiber from both the directions is shown in Table 2.

TABLE 2

Application to one surface
Application to both surfaces
Removal by chemical

Table 2 shows an example of the measurement of tensile strength (Kgf) in a case where the laser beam is applied to one surface of the coated optical multi fiber to remove the coating, in a case where the laser beams are applied to both the surfaces of the coated optical multi fiber to remove the coating, and in a case where the coating is removed by a chemical. As can be seen from Table 2, when the laser beams are applied to both the surfaces of the coated optical multi fiber, the coating can be removed in a short time and hence the deterioration of the bared optical fibers is reduced, which is at the same level as in the case where the coating is removed by a chemical.

The coated optical multi fiber 24 is gripped by the clamping part of the stage 17 and the stage 17 is moved in the axial direction of the coated optical fiber, so that the laser beam 12 removes the coating of the coated optical multi fiber 24 by fusion or the like. In this manner, the coating can be removed along the axial direction of the coated optical fiber. The same effect can be obtained also by fixing the stage 17 and moving the mirror 13 in the axial direction of the coated optical fiber. Further, the same effect can be obtained also by collecting the laser beam in the shape of a belt or a line in the axial direction of the coated optical fiber and moving the stage 17 or the mirror 13 in a direction perpendicular to the axial direction of the coated optical fiber.

A nitrogen gas as inert gas is blown from the gas nozzle 15 to discharge an oxygen atmosphere from the vicinity of a portion to which the laser beam is applied. The nitrogen gas is used to prevent the bared optical fiber from being deteriorated in strength.

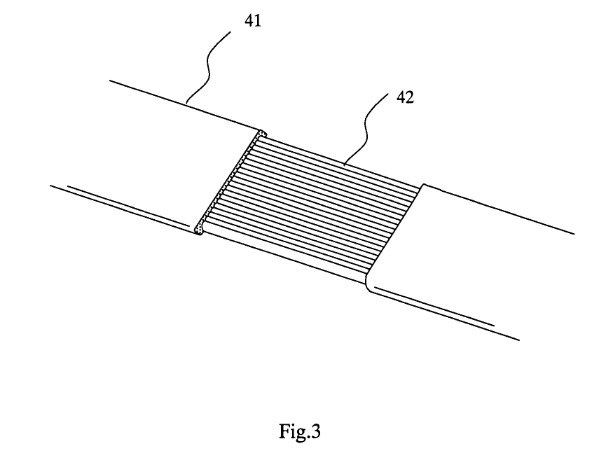

In this embodiment, an example of removing the coating of the coated optical multi fiber in a collective manner is shown in FIG. 3. A reference numeral 41 denotes a coated optical multi fiber having bared optical fibers integrally formed in the shape of a tape by means of the coating material and 42 denotes a bared optical fiber whose coating is removed. In this manner, the coating can be removed at an arbitrary position in a midpoint portion of the coated single optical fiber or the coated optical multi fiber, which was very difficult in a conventional method. For this reason, a portion whose coating is removed can be provided for a coupler of a singl optical fiber or a optical multi fiber.

The laser beam collected in the shape of a belt by the cylindrical lens has a width of 0.5 mm and a length of 20 mm and hence can uniformly remove the coating of the coated optical multi fiber formed in the shape of a tape in a width of 20 mm. This means that in the case of a standard coated optical fiber having a diameter of 250 μm, the coating of a coated optical multi fiber having as many bared optical fibers as 80 can be removed in a collective manner.

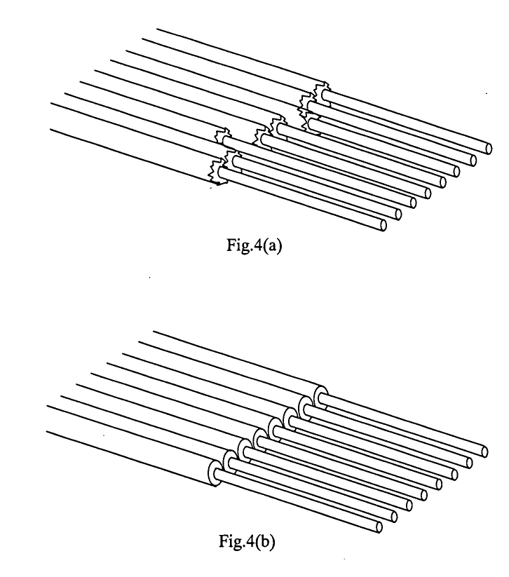

Further, in the case of using a method for removing the coating mechanically as in the case of using the hot stripper, the coating is sheared and hence the boundaries between portions from which the coatings are removed and coated optical fibers become uneven. The boundaries between portions from which the coatings are removed and coated optical fibers are shown in FIG. 4. FIG. 4(a) shows an example in which the coating is removed by the hot stripper. As can be seen, the boundaries between portions from which the coatings are removed and coated optical fiber are uneven and the boundary surfaces of portions from which the coatings are removed are not smooth. For this reason, in a conventional method using the hot stripper, in a case where the optical fiber is connected to an optical part or in a case where the optical fibers are fused and spliced to each other, the end surfaces of portions from which the coatings are removed enter uselessly between the bared optical fibers to widen the bared optical fibers to make it difficult to align the bared optical fibers uniformly.

According to the invention, as shown in FIG. 4(b), the end surface of the coating has been removed is made smooth. Moreover, the boundary surfaces of the respective fibers of the coated optical multi fiber can be neatly aligned. Further, since the portion from which the coating is removed can be made short in length, a protective area when the bared optical fibers are fused and spliced to each other can also be made small, which can realize the size reduction of an optical device.

In this regard, in the construction shown in FIG. 2, the laser beam from one LASER is divided and applied to the coated optical fiber. However, it is also recommended that laser beams are applied to the coated optical fiber from the upper and lower directions via cylindrical lenses by use of two LASERs. In this case, the half mirror 22 and the plurality of mirrors 13 are not required.

Moreover, it is for the purpose of removing the coating efficiently that the laser beams are applied to both the surfaces of the coated optical fiber. Hence, the laser beam may be applied only to one surface to remove the coating or may be applied to each of the surfaces separately. In addition, when the laser beam is applied to the coated optical fiber in a direction at right angle to the axis of the coated optical fiber, the degree of irradiation efficiency can be increased, but in a case where a low degree of irradiation efficiency can be allowed, the laser beam does not have to be applied to the coated optical fiber in a direction at right angle.

### Embodiment 3

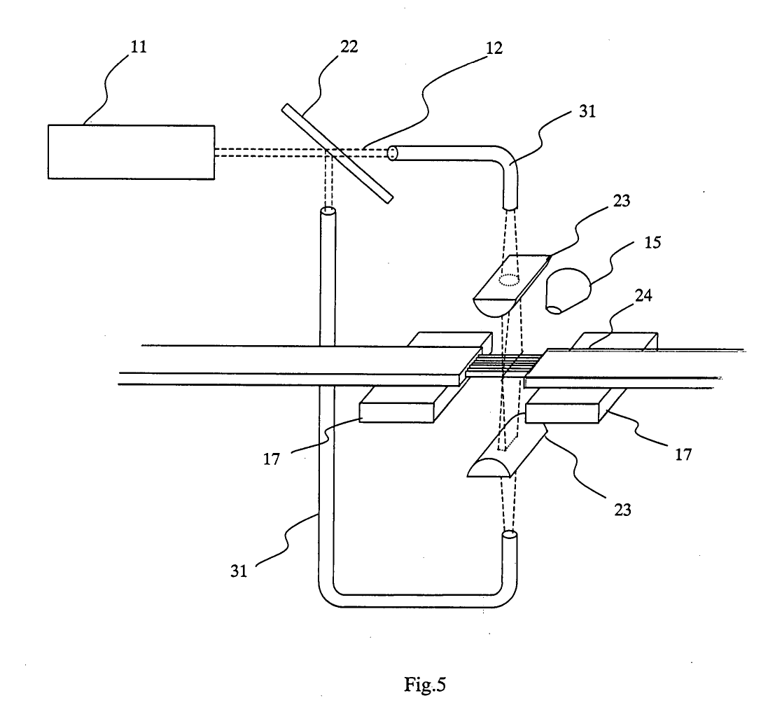

An embodiment of removing the coating of the coated optical multi fiber is shown in FIG. 5. In Embodiment 2, the laser beam is guided by use of a spatial beam, but in FIG. 5, an optical system using a hollow fiber coated with silver is used. In FIG. 5, a reference numeral 11 denotes a LASER emitting a laser beam 12, 22 denotes a half mirror, 13 denotes a mirror reflecting the laser beam, 31 denotes a hollow fiber for guiding the laser beam, 23 denotes a cylindrical lens for focusing a circular laser beam into the shape of a belt, 15 denotes a gas nozzle for blowing inert gas over a portion of the optical fiber to which the laser beam 12 is applied, 24 denotes a coated optical multi fiber having bared optical fibers integrally formed in the shape of a tape by means of the coating material, and 17 denotes a stage moving the coated optical multi fiber 24 in the axial direction of the coated optical fiber.

In this embodiment, the laser beam of high energy is not propagated in air, so that safety can be improved. Moreover, since the optical system becomes simple, the coating of the coated optical fiber can be easily removed by moving the belt-shaped laser beam.

### Embodiment 4

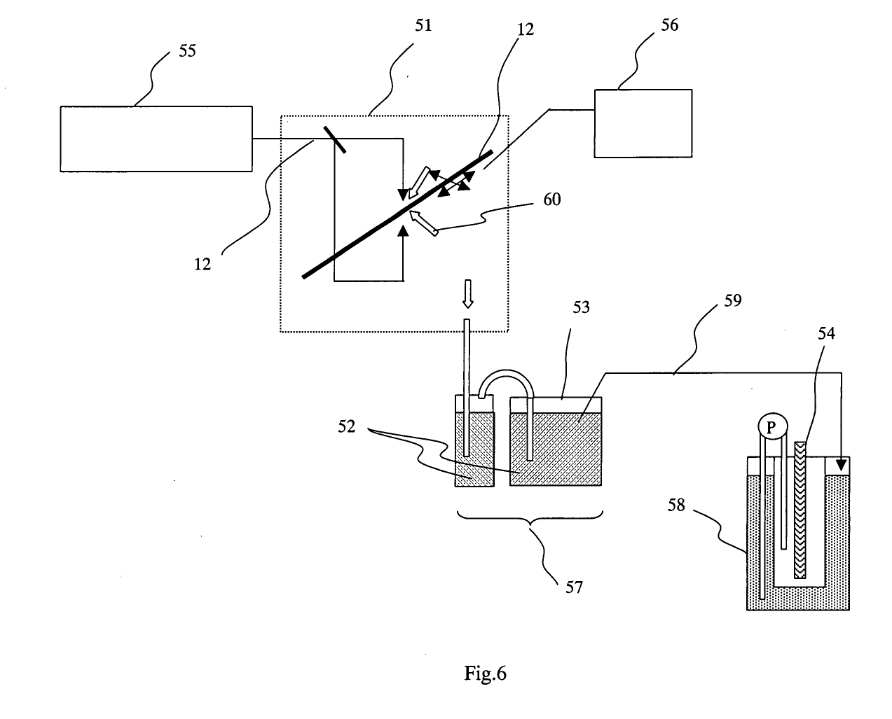

In this embodiment, an exhaust gas treating system is further connected to Embodiment 2. This embodiment is shown in FIG. 6. This embodiment is different from Embodiment 2 in the following points: a part for applying the laser beam 12 from a carbon dioxide gas laser 55 to a tape-shaped optical multi fiber 24 is constructed as a hermetically sealing system in a chamber 51; parts for blowing inert gas over the coated optical multi fiber 24 are mounted in a slanting direction at two upper and lower positions; and exhaust gas from the chamber 51 is introduced into an exhaust gas treating system 57. The tape-shaped optical multi fiber 24 has its motion controlled by a control system 56.

The coating of the coated optical fiber 24 was removed by use of the carbon dioxide gas LASER 55 and then the present inventor checked generated gas and detected a toxic cyanogen gas. No substance having a detrimental effect on a human body was detected except for the cyanogen gas. Hence, the part for applying the laser beam 12 to the coating of the coated optical fiber 24 by use of the carbon dioxide gas laser is constructed as the hermetically sealing system in the chamber 51 and the exhaust gas treating system 57 is connected to the chamber 51. A waste liquid treating system 58 capable of decomposing cyanogen is provided in connection to the exhaust gas treating system 57. Waste liquid 59 is transferred from the exhaust gas treating system 57 to the waste liquid treating system 58. In the waste liquid treating system 58, the cyanogen is irradiated with ultraviolet rays by use of a mercury lamp 54 and at the same time is made to react with ozone, thereby being decomposed into carbon dioxide and nitrogen dioxide.

In FIG. 6, a laser beam application part is hermetically sealed in the chamber 51. Nitrogen gas 60 as inert gas is introduced into the chamber 51 from two gas blowing parts and the exhaust gas treating system 57 is connected to the chamber 51. In this exhaust gas treating system, first, nitrogen gas and cyanogen gas are passed through an alkaline liquid 52. The nitrogen gas does not dissolve in the alkaline liquid but the cyanogen gas reacts with the alkaline liquid and dissolves therein. Hence, the cyanogen is trapped by the alkaline liquid 52. Next, the treated exhaust gas is sucked by a vacuum pump (aspirator 53). Further, in the waste liquid treating system 58, the alkaline liquid in which the cyanogen is trapped is irradiated with ultraviolet rays by use of the mercury lamp 54. The mercury lamp 54 is so constructed as to generate ozone from oxygen in air and at the same time to irradiate the alkaline liquid with ultraviolet rays. For this reason, the cyanogen in the alkaline liquid is decomposed into harmless carbon dioxide and nitrogen dioxide. The cyanogen was not detected in the alkaline liquid having passed through this waste liquid treating system 58.

According to this embodiment, it is possible to eliminate a detrimental effect on the body of a worker to perform the work of removing the coating of the coated optical fiber. In this embodiment, the gas blowing parts are provided at two upper and lower positions, but arbitrary pieces of gas blowing parts can be provided at arbitrary positions where inert gas can be introduced into the chamber. Further, while the mercury lamp is used for treating the cyanogen, any treatment can be used if it can treat cyanogen gas.

In this embodiment, the laser beam applying part is hermetically sealed in the chamber and the cyanogen gas is dissolved in the alkaline liquid in the exhaust gas treating system and then the dissolved cyanogen is decomposed by ozone. However, it is also possible only to exhaust the cyanogen gas from the chamber and then treat the exhausted cyanogen gas in a separate unit. Further, it is also possible to exhaust the cyanogen gas from the chamber, dissolve the cyanogen gas in the alkaline liquid and then treat cyanogen trapped in the alkaline liquid in a separate place.

1. A method for manufacturing a bared optical fiber in which a laser beam is applied to a coated optical fiber:
to fuse a coating if a coating material has a lower melting point as compared with a material of the bared optical fiber;
to fuse and volatilize the coating if the coating material has a lower volatilizing point as compared with the material of the bared optical fiber;
to sublimate the coating if the coating material has a lower sublimating temperature as compared with the material of the bared optical fiber; or
to thermally oxidize and decompose the coating if the coating material has a lower thermally oxidizing temperature as compared with the material of the bared optical fiber; or
to fuse, fuse and volatilize, sublimate, or thermally oxidize and decompose the coating if the coating material has a higher index of absorption of a laser beam as compared with the material of the bared optical fiber, thereby removing the coating.

2. A method for manufacturing a bared optical fiber in which a laser beam is applied to a coated optical fiber:
to photolyze a coating if a coating material is easily photolyzed as compared with a material of the bared optical fiber; or
to photolyze the coating if the coating material has a higher index of absorption of a laser beam as compared with the material of the bared optical fiber, thereby removing the coating.

3. The method for manufacturing a bared optical fiber according to claim 1 or claim 2, wherein the laser beam is collected in the shape of a belt or a line and is applied to the coated optical fiber in an axial direction of the coated optical fiber or in a direction crossing the axial direction.

4. The method for manufacturing a bared optical fiber according to claim 1 or claim 2, wherein plurality of laser beams are applied to the coated optical fiber from different directions.

5. The method for manufacturing a bared optical fiber according to claim 1 or claim 2, wherein the laser beam is applied to the coated optical fiber while the laser beam is being moved in an axial direction of the coated optical fiber or in a direction crossing the axial direction.

6. The method for manufacturing a bared optical fiber according to claim 1 or claim 2, wherein plurality of laser beams are applied to the same portion of the coated optical at the same time.

7. The method for manufacturing a bared optical fiber according to claim 1 or claim 2, wherein the coated optical fiber is a coated optical multi fiber having bared optical fibers integrally formed by means of the coating material.

8. The method for manufacturing a bared optical fiber according to claim 1, wherein the laser beam is generated by a carbon dioxide gas laser.

9. The method for manufacturing a bared optical fiber according to claim 1, wherein the laser beam is generated by a semiconductor laser.

10. The method for manufacturing a bared optical fiber according to claim 2, wherein the laser beam is generated by an excimer laser.

11. The method for manufacturing a bared optical fiber according to claim 1 or claim 2, comprising a means that exhausts gas generated when the laser beam is applied to the coated optical fiber.

12. The method for manufacturing a bared optical fiber according to claim 11, comprising a means that makes a cyanogen gas of the exhausted gas react with an alkaline liquid to dissolve the cyanogen gas in the alkaline liquid.

13. The method for manufacturing a bared optical fiber according to claim 12, further comprising a means that further decomposes the dissolved cyanogen by ozone.

14. The method for manufacturing a bared optical fiber according to claim 1 or claim 2, wherein inert gas is introduced to a portion of the coated optical fiber to which the laser beam is applied.

15. A device for manufacturing a bared optical fiber, comprising a laser applying part that applies a laser beam to a coated optical fiber to remove a coating of the coated optical fiber.

16. The device for manufacturing a bared optical fiber according to claim 15, wherein the laser applying part collects a laser beam on the coated optical fiber in the shape of a belt or a line and applies the laser beam to the coated optical fiber in an axial direction of the coated optical fiber or in a direction crossing the axial direction.

17. The device for manufacturing a bared optical fiber according to claim 15, wherein the laser applying part applies plurality of laser beams to the coated optical from different directions.

18. The device for manufacturing a bared optical fiber according to claim 15, wherein the laser applying part applies the laser beam to the coated optical fiber while the laser beam is being moved in an axial direction of the coated optical fiber or in a direction crossing the axial direction.

19. The device for manufacturing a bared optical fiber according to claim 15, wherein the laser applying part applies plurality of laser beams to the same portion of the coated optical fiber at the same time.

20. The device for manufacturing a bared optical fiber according to claim 15, wherein the laser applying part applies the laser beam to a coated optical multi fiber having bared optical fibers integrally formed by means of the coating material to remove the coating.

21. The device for manufacturing a bared optical fiber according to claim 15, wherein the laser applying part has a carbon dioxide gas laser, a semiconductor laser, or an excimer laser.

22. The device for manufacturing a bared optical fiber according to claim 15, further comprising a means that exhausts gas generated when the laser beam is applied to the coated optical fiber.

23. The device for manufacturing a bared optical fiber according to claim 22, further comprising a means that makes a cyanogen gas of the exhausted gas react with an alkaline liquid to dissolve the cyanogen gas in the alkaline liquid.

24. The device for manufacturing a bared optical fiber according to claim 23, further comprising a means that further decomposes the dissolved cyanogen by ozone.

25. The device for manufacturing a bared optical fiber according to claim 15, further comprising a means that introduces inert gas to a portion of the coated optical fiber to which the laser beam is applied.
